(19) United States
(12) Patent Application Publication
(10) Pub. No.: US 2018/0307099 A1
(43) Pub. Date: Oct. 25, 2018

(54) NIGHT VISION COMPATIBLE AVIONICS DISPLAY

(71) Applicant: General Electric Company, Schenectady, NY (US)

(72) Inventor: Mark Marshall Meyers, Mechanicville, NY (US)

(21) Appl. No.: 15/491,815

(22) Filed: Apr. 19, 2017

(51) Int. Cl. G02F 1/1335

(52) U.S. Cl. CPC G02F 1/133603; G02F 1/133621; G02F 2202/36; G02F 2001/133614; G02F 1/133606

(57) ABSTRACT

A display includes a blue light emitting diode (LED) and a transparent shell disposed over the blue LED. The transparent shell includes a plurality of red quantum dots configured to absorb light from the blue LED and emit light in a red spectral region.

### BACKGROUND

The subject matter disclosed herein relates to displays, and more specifically to avionics displays for use with night vision goggles.

In order to avoid detection, military activities may be undertaken in complete darkness. Pilots and crew of aircraft may utilize night vision goggles in order to be able to see infrared (IR) emissions from various sources of interest (e.g., people, engines, etc.). Typical fluorescent or white light emitting diode (LED) backed displays emit light in the near IR spectrum (900-1100 nm), causing blooming or saturation in night vision goggles, such that a person wearing night vision goggles cannot see what is being displayed.

### BRIEF DESCRIPTION

Certain embodiments commensurate in scope with the original claims are summarized below. These embodiments are not intended to limit the scope of the claims, but rather these embodiments are intended only to provide a brief summary of possible forms of the claimed subject matter. Indeed, the claims may encompass a variety of forms that may be similar to or different from the embodiments set forth below.

In one embodiment, a display includes a blue light emitting diode (LED) and a transparent shell disposed over the blue LED. The transparent shell includes a plurality of red quantum dots configured to absorb light from the blue LED and emit light in a red spectral region.

In a second embodiment, a method of manufacturing a display includes installing a transparent shell over one or more blue LEDs. The transparent shell comprises a plurality of red quantum dots configured to absorb light from the blue LED and emit light in a red spectral region, wherein the plurality of red quantum dots are configured to emit light having a peak emission at 635 nm or less.

In a third embodiment, a method of operating a display includes emitting light in a blue spectral region via one or more blue LEDs, absorbing the light emitted by the one or more blue LEDS, via one or more red quantum dots disposed on one or more shells disposed over the one or more blue LEDs, emitting light in a red spectral region, wherein the one or more red quantum dots are configured to emit light having a peak emission at 635 nm or less, and transmitting, via the one or more shells, light in the blue spectral region emitted by the one or more blue LEDs.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side, section view of a display, in accordance with an embodiment;

FIG. 2 is an absorption and emission spectrum plot quantum dots having a peak emission with a wavelength of 590 nm, in accordance with an embodiment;

FIG. 3 is a flow chart of a process for manufacturing the display of FIG. 1, in accordance with an embodiment; and

FIG. 4 is a flow chart of a process for operating the display of FIG. 1, in accordance with an embodiment;

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

Military operations involving aircraft (e.g., helicopters, planes, etc.) are sometimes carried out at night and in complete darkness to avoid detection. During these activities, pilots and crew of aircraft may utilize night vision goggles to see infrared (IR) emissions from various sources of interest (e.g., people engines, etc.). Fluorescent and white light emitting diode (LED) back displays emit light in the near IR spectrum (900-1100 nm), which, when viewed through night vision goggles, may cause blooming or saturation, making it difficult for the user to see what is being displayed. A glass plate coated with a low pass dielectric filter laid over the display may prevent the light in the near IR spectrum from being emitted, but filters out many of the red colors emitted by the display. Further, such techniques add weight to the display, increase cost, and lead to reduced contrast in the display, as seen by the user.

By using a transparent domes equipped with red and green quantum dots, and disposed over blue LEDS, a display may emit high quality red colors without emitting light in the near IR spectrum. Such a display would not cause saturation or blooming when viewed by a user wearing night vision goggles.

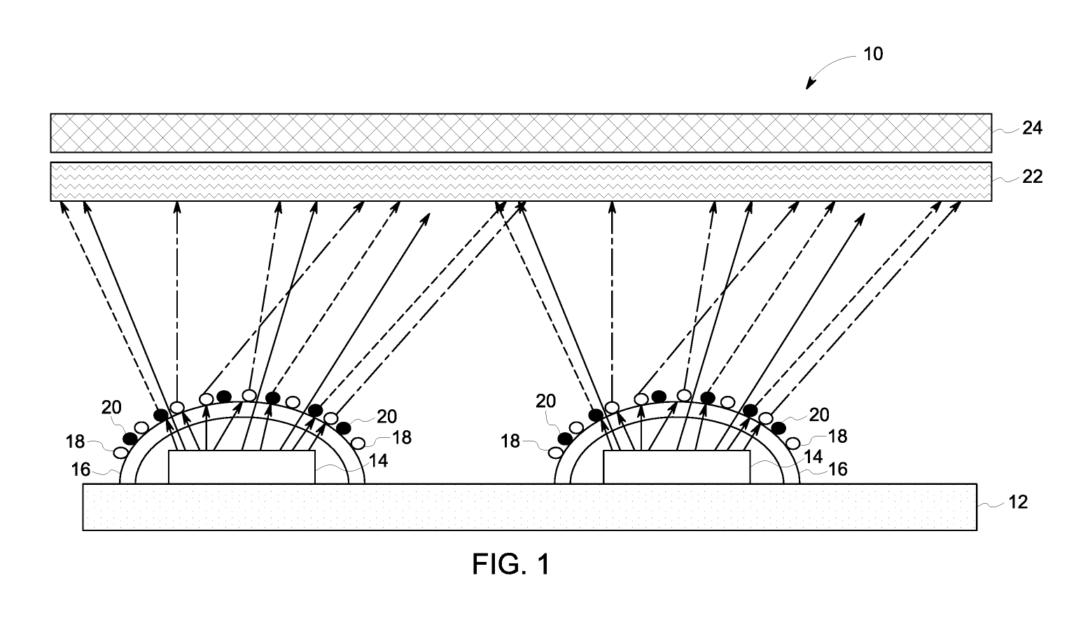

Turning now to the figures, FIG. 1 is side-section view of a display 10. The display 10 includes a baseplate 12 (e.g., a substrate) and an array of blue LEDs 14. Disposed over the blue LEDs 14 are transparent shells 16. Each shell 16 may cover multiple blue LEDs 14, or a single blue LED 14. Each shell 16 may have a substantially hemispherical or dome shape. Each shell 16 may be made of glass, a polymer, or some other transparent material. Disposed on an exterior surface of, an interior surface of, or within the material forming each shell 16, may be green quantum dots 18 and red quantum dots 20. By offsetting the quantum dots 18, 20 from the blue LED 14, the quantum dots 18, 20 are not exposed to the heat dissipated by the blue LED 14.

Based on the sizes of the quantum dots 18, 20, the green and red quantum dots 18, 20 absorb light in the spectral region emitted by the blue LED 14 (e.g., peak emission around 450-460 nm) and then emit light in the green spectral region (e.g., peak emission around 540-550 nm) and the red spectral region (e.g., peak emission around 620-635 nm), respectively. Though the red spectral region typically covers 620-740 nm, light emitted at the high end of the spectral region (e.g., starting from 650 nm, 675 nm, or 700 nm and ranging to approximately 740 nm) may cause blooming or saturation when viewed through night vision goggles. Accordingly, the red quantum dots 20 may be configured to absorb light from the blue LED 14 and emit light having peak emission at a wavelength of no more than approximately 620 nm, 625 nm, or 630 nm, a bandwidth of 30 nm or less, and/or low or no intensity at wavelengths above 640 nm. Green light emitted by the green quantum dots 18, red light emitted by the red quantum dots 20, and the blue light emitted by the blue LED 14 that passes through the shell 16 simulate green, red, and blue pixels, respectively, which may be used in combination to generate a range of colors on the display 10.

As illustrated, a diffuser 22 and an LCD 24 may be installed above the base plate 12, the blue LEDS 14, and the shells 16. The diffuser 22 scatters and reflects the light emitted by the blue LEDs 14, the green quantum dots 18, and the red quantum dots 20 before it hits the LCD 24. The diffuser 22 homogenizes the red and green backlight intensity, making them more uniform before being transmitted through the LCD 24. The LCD 24 may selectively transmit the light received from the diffuser 22 such that the sources of blue, green, and red light act as pixels to generate a displayed image. Because light emitted by the display 10 has a very low or no intensity in the near IR spectral region (e.g., 700-110 nm), the display 10 can be viewed through night vision goggles without a secondary low pass dielectric filter. Further, to the naked eye, the display 10 provides a full RGB display with reasonable color gamut for viewing full color images.

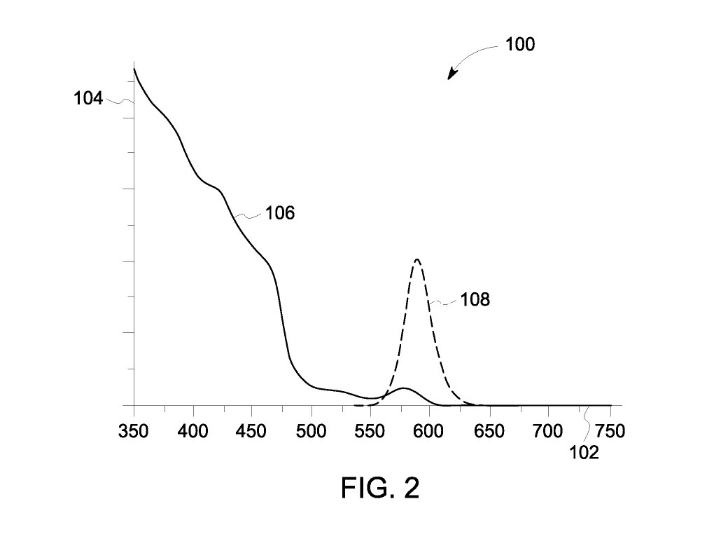

FIG. 2 is an absorption and emission spectrum plot for “Series A Plus CANdots from CAN GmbH of Hamburg Germany, having a peak emission with a wavelength of 590 nm. The horizontal axis 102 represents wavelength in nm and the vertical axis 104 represents intensity. As illustrated by line 106, the dots absorb light having a wavelength of mostly 300-500 nm and then emit light (line 108) with a peak emission at 590 nm, and little to no intensity above about 650 nm. It should be understood, however, that FIG. 2 is merely an example of how quantum dots absorb light from a first range of wavelengths and then emit light having a second range of wavelengths. Accordingly, CANdots are available in various versions designed to emit light in different wavelength ranges.

Quantum dots include nanoparticles and are typically composed of cadmium selenide (CdSe) or cadmium sulfide (CdS), but quantum dots of other materials may be possible. The peak emission wavelength of a quantum dot may be adjusted by controlling the radius of the quantum dot during synthesis. The larger the radius of the quantum dot, the longer the emission wavelength. By designing quantum dots that do not emit light in the near IR spectral region (700-1100 nm), the resulting display may be capable of displaying rich colors that do not result in blooming or saturation when viewed through night vision goggles. For example, the resulting display may be compatible with Military Standard 3009 (“MIL-STD-3009”).

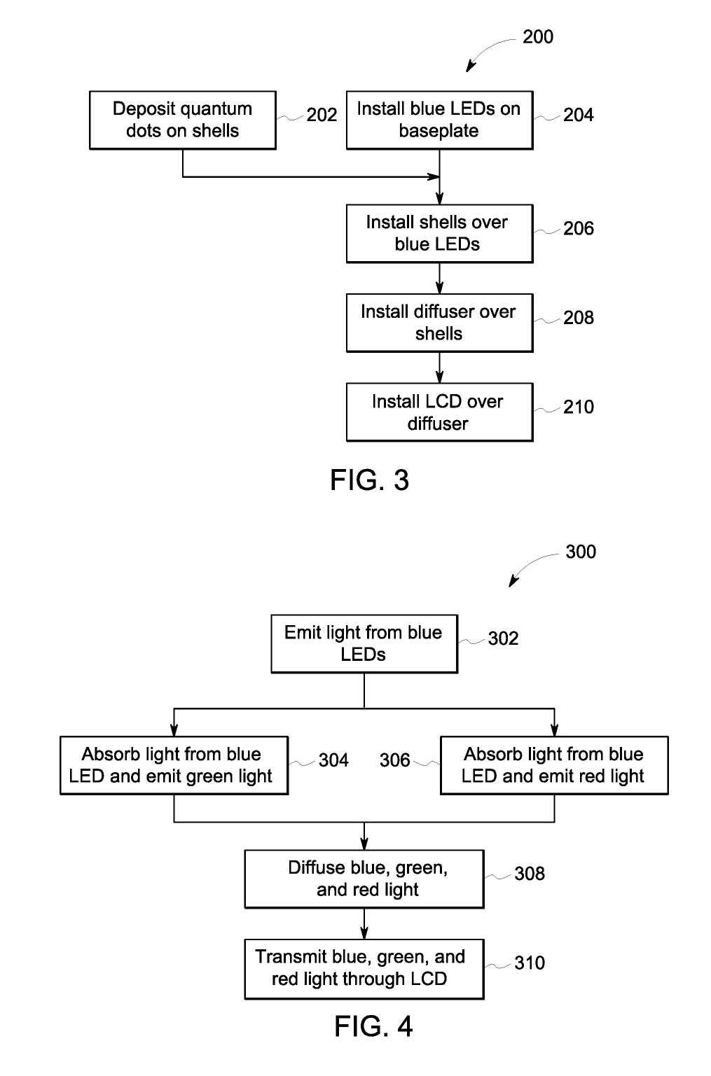

FIG. 3 is a flow chart of a process 200 for manufacturing the display 10 shown in FIG. 1. In block 202, the green and red quantum dots are deposited on the shells. As previously discussed, the shells may be hemispherical or dome shaped and may be made of glass, a polymer, or another transparent material. The green and red quantum dots may be made of nanoparticles including cadmium selenide (CdSe), cadmium sulfide (CdS), or some other appropriate material. The radii of the quantum dots may be selected such that the quantum dots have a low intensity (e.g., 1% of the peak intensity, or between 0% and 20% of the peak intensity) at a wavelength greater than 630 nm, 640 nm, 650 nm, 660 nm, 670 nm, 680 nm, 690 nm, or 700 nm, or do not emit light with a wavelength greater than 630 nm, 640 nm, 650 nm, 660 nm, 670 nm, 680 nm, 690 nm, or 700 nm. The green quantum dots may have a radius selected to have peak emission at 540-550 nm. The red quantum dots may have a radius selected to have peak emission at 620-635 nm. In the embodiment illustrated in FIG. 1, the quantum dots are disposed on an exterior surface of each shell. However, the quantum dots may also be deposited on an interior surface of the shells, or suspended within the material that forms the shell.

In block 204, the blue LEDs are installed on the baseplate. The blue LEDs may be distributed across the baseplate in a two-dimensional array, or in some other pattern. In some embodiments the baseplate and the blue LEDs may be purchased from different vendors and assembled, or the baseplate may be purchased from a vendor with the blue LEDs already installed.

In block 206, the shells are installed over the blue LEDs. In some embodiments, a shell may cover a single blue LED. In other embodiments, the shell may cover multiple blue LEDs. For example, in some embodiments, each shell may cover a row or column of LEDs. In other embodiments, each shell may cover a two-dimensional array of blue LEDs.

In block 208, the diffuser is installed over the shells. As previously described, the diffuser is configured to scatter and reflect the light emitted by the blue LEDs and the green and red quantum dots before the light hits the LCD. The diffuser homogenizes the red and green backlight intensity, making them more uniform before being transmitted through the LCD.

In block 210, the LCD is installed over the diffuser. Because light emitted by the display through the LCD has a very low or no intensity in the near IR spectral region (e.g., 700-110 nm), the display can be viewed through night vision goggles without a secondary low pass dielectric filter. Further, to the naked eye, the display provides a full RGB display with reasonable color gamut for viewing full color images.

FIG. 4 is a flow chart of a process 300 for operating the display 10 of FIG. 1. In block 320, light is emitted from a plurality of blue LEDs. The light emitted may have a wavelength in the blue spectral region, with peak emission around 450-460 nm. The blue LEDs may be disposed on a baseplate or substrate in a two-dimensional array. The plurality of LEDs may have shells disposed over them. In some embodiments, each blue LED may have a corresponding shell. In other embodiments, each shell may cover multiple LEDs. Each shell may have quantum dots disposed on an interior surface of the shell, an exterior surface of the shell, or within the material that forms the shell. The quantum dots may be configured to absorb the light emitted by the blue LEDs and emit light having a different wavelength.

In block 304, the green quantum dots disposed on the shells absorb light from the blue LEDs (e.g., peak emission around 450-460 nm) and emit light in the green spectral region (e.g., peak emission around 540-550 nm). In block 306, the red quantum dots disposed on the shells absorb light from the blue LEDs (e.g., peak emission around 450-460 nm) and emit light in the red spectral region (e.g., peak emission around 620-635 nm). Though the red spectral region typically covers 620-740 nm, as previously discussed, light emitted at the high end of the spectral region (e.g., starting from 650 nm, 675 nm, or 700 nm and ranging to approximately 740 nm) may cause blooming or saturation when viewed through night vision goggles. Accordingly, the red quantum dots may be configured to absorb light from the blue LED and emit light having peak emission at a wavelength of no more than approximately 620 nm, 625 nm, or 630 nm, a bandwidth of 30 nm or less, and no intensity or very low intensity (e.g., 1% of the peak intensity, or between 0% and 20% of the peak intensity) at wavelengths above 640 nm. Additionally, it should be understood that some of the blue light emitted from the blue LEDs is transmitted through the shells. Accordingly, the light in the blue spectral region (e.g., peak emission around 450-460 nm), the green spectral region (e.g., peak emission around 540-550 nm), and the red spectral region (e.g., peak emission around 620-635 nm) may propagate outward from the shell toward the diffuser.

In block 308, the diffuser diffuses the blue, green, and red light received from the shell. The diffuser scatters and reflects the light emitted by the blue LEDs and the green and red quantum dots before the light hits the LCD. The diffuser homogenizes the red and green backlight intensity, making them more uniform before being transmitted through the LCD.

In block 310, the LCD transmits the blue, green, and red light received from the diffuser. The LCD may selectively transmit the light received from the diffuser such that the sources of blue, green, and red light act as pixels to generate a displayed image visible to users with and without night vision goggles.

Technical effects of the disclosure include using green and red quantum dots in coordination with blue LEDs to backlight a display that emits light with no intensity, or very low intensity in the near-IR spectral region, such that there is not blooming or saturation when the display is viewed through night vision goggles. However, when viewed with the naked eye, the display is capable of displaying a rich gamut of colors, including reds.

This written description uses examples to disclose the claimed subject matter, including the best mode, and also to enable any person skilled in the art to practice the disclosed subject matter, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A display, comprising:
a blue light emitting diode (LED); and
a transparent shell disposed over the blue LED, the transparent shell comprising a plurality of red quantum dots configured to absorb light from the blue LED and emit light in a red spectral region;
wherein the blue LED is configured to emit light having a peak emission between 450 nm and 460 nm.

2. The display of claim 1, wherein the transparent shell comprises a plurality of green quantum dots configured to absorb light from the blue LED and emit light in a green spectral region.

3. The display of claim 1, wherein the plurality of red quantum dots are configured to emit light having a peak emission at 635 nm or less.

4. The display of claim 1, wherein the plurality of red quantum dots are configured to emit light having a peak emission between 620 nm and 635 nm.

5. The display of claim 1, wherein the red quantum dots do not emit light having a wavelength greater than 640 nm.

6. (canceled)

7. The display of claim 1, wherein the blue LED is coupled to a baseplate.

8. The display of claim 7, comprising a liquid crystal display (LCD) disposed opposite the baseplate.

9. The display of claim 8, comprising a diffuser disposed between the transparent shell and the LCD.

10. The display of claim 1, wherein the transparent shell is made of glass.

11. A method of manufacturing a display, comprising:
installing a transparent shell over one or more blue LEDs, wherein the transparent shell comprises a plurality of red quantum dots configured to absorb light from the blue LED and emit light in a red spectral region, wherein the plurality of red quantum dots are configured to emit light having a peak emission at 635 nm or less;
wherein each of the one or more blue LED is configured to emit light having a peak emission between 450 nm and 460 nm.

12. The method of claim 11, comprising:
installing the one or more blue LEDs on a baseplate;
installing a liquid crystal display opposite the baseplate; and
installing a diffuser between the transparent shell and the LCD.

13. The method of claim 12, wherein the transparent shell comprises a plurality of green quantum dots configured to absorb light from the blue LED and emit light in a green spectral region.

14. The method of claim 13, comprising depositing the red and green quantum dots on the transparent shell.

15. A method of operating a display, comprising:
emitting light in a blue spectral region via one or more blue LEDs;
absorbing the light emitted by the one or more blue LEDS, via one or more red quantum dots disposed on one or more shells disposed over the one or more blue LEDs, and emitting light in a red spectral region, wherein the one or more red quantum dots are configured to emit light having a peak emission at 635 nm or less; and
transmitting, via the one or more shells, light in the blue spectral region emitted by the one or more blue LEDs;
wherein each of the one or more blue LED is configured to emit light having a peak emission between 450 nm and 460 nm.

16. The method of claim 15, comprising absorbing the light emitted by the one or more blue LEDS, via one or more green quantum dots disposed on the one or more shells disposed over the one or more blue LEDs, and emitting light in a green spectral region

17. The method of claim 16, comprising diffusing, via a diffuser, the light transmitted by the one or more shells, the light emitted by the one or more green quantum dots, and the light emitted by the one or more red quantum dots.

18. The method of claim 17, comprising operating an LCD to selectively transmit the light transmitted by the one or more shells, the light emitted by the one or more green quantum dots, and the light emitted by the one or more red quantum dots to display an image.

19. The method of claim 15, wherein the one or more red quantum dots are configured to emit light having a peak emission between 620 nm and 635 nm

20. The method of claim 15, wherein the one or more red quantum dots do not emit light having a wavelength greater than 640 nm.

21. The display of claim 1, wherein the transparent shell has a hemispherical or a dome shape.

22. The display of claim 2, wherein the plurality of red quantum dots and the plurality of green quantum dots are designed to not emit light in the IR spectral region 700-1100 nm.

23. The display of claim 2, wherein the plurality of red quantum dots and the plurality of green quantum dots are made of nanoparticles including cadmium selenide (CdSe) or cadmium sulfide (CdS).

24. The display of claim 2, wherein the plurality of red quantum dots have a radius selected to have peak emission at 620-635 nm and the plurality of green quantum dots have a radius selected to have peak emission at 540-550 nm.

25. The display of claim 2, wherein a radii of the plurality of red quantum dots and the plurality of green quantum dots is selected such that the plurality of red quantum dots and the plurality of green quantum dots do not emit light with a wavelength greater than 630 nm, 640 nm, 650 nm, 660 nm, 670 nm, 680 nm, 690 nm, or 700 nm.
